(19) United States
(12) Patent Application Publication
(10) Pub. No.: US 2012/0285884 A1
(43) Pub. Date: Nov. 15, 2012

(54) Calcium Oxide Cement Kiln Dust for Granulation of Palm Oil Mill Effluent

(75) Inventor: Anwar Ahmad, Gambang (MY)

(73) Assignee: UNIVERSITI MALAYSIA PAHANG, Gambang (MY)

(21) Appl. No.: 13/191,419

(22) Filed: Jul. 26, 2011

(30) Foreign Application Priority Data
May 10, 2011 (MY) PI 2011002076

(51) Int. Cl. C02F 11/04

(52) U.S. Cl. 210/603; 210/610

(57) ABSTRACT

A use of calcium oxide-cement kiln dust (CaO-CKD) for anaerobic granulation of palm oil mill effluent. A process to produce biogas from palm oil mill effluent using calcium oxide-cement kiln dust (CaO-CKD) wherein steps include inoculating palm oil mill effluent sludge in a reactor, conducting anaerobic digestion on the sludge and conducting anaerobic granulation of palm oil mill effluent.

### CROSS-REFERENCE TO RELATED APPLICATION

This application claims priority to and the benefit of Malaysia Patent Application No. PI2011002076, filed on May 10, 2011, the entire contents of which are incorporated herein by reference.

### BACKGROUND

1. Field of Invention

The present invention relates to a use of calcium oxide-cement kiln dust (CaO-CKD) for granulation of palm oil mill effluent.

2. Background of Invention

In the recent years, much emphasis has been placed on the significance of anaerobic granulation technology in meeting demands of exploring broader applications for removal of unwanted organic pollutants by converting them into biogas, namely methane, a renewable energy source. Anaerobic treatment using sludge granulation has gained tremendous success in the past for treatment of a variety of industrial effluents. Some of the advantages using this technology are low operating costs, compact reactor construction, production of energy in the form of biogas, and low surplus sludge production, as compared to aerobic granulation. In U.S. Pat. No. 6,793,822, a method of producing aerobic biogranules for the treatment of waste water is disclosed. However, this technology has some drawbacks, including additional operating costs of aeration.

The formation of anaerobic granular sludge is considered as the major reason of the successful introduction of the Upflow Anaerobic Sludge Bed (UASB) reactor concept for anaerobic treatment of industrial effluents. This granulation process allows loading rates in UASB reactors far beyond common loading rates applied so far in conventional activated sludge processes. The resulting reduction in reactor size and required area for the treatment leads to lower investment costs in addition to the reduced operating costs due to the absence of aeration.

### SUMMARY OF INVENTION

Accordingly, the present invention provides a use of calcium oxide-cement kiln dust (CaO-CKD) of a concentration range from 1.5 gL⁻¹ to 20 gL⁻¹ for anaerobic granulation of palm oil mill effluent.

The present invention also relates to a process to produce biogas from palm oil mill effluent using calcium oxide-cement kiln dust (CaO-CKD) wherein steps include inoculating palm oil mill effluent sludge in a reactor, conducting anaerobic digestion on the sludge and conducting anaerobic granulation of palm oil mill effluent.

### BRIEF DESCRIPTION OF DRAWINGS

The drawings constitute part of this specification and include an exemplary or preferred embodiment of the invention, which may be embodied in various forms. It should be understood, however, the disclosed preferred embodiments are merely exemplary of the invention. Therefore, the figures disclosed herein are not to be interpreted as limiting, but merely as the basis for the claim and for teaching one skilled in the art of the invention.

In the appended drawings:

FIG. 1 illustrates an experimental setup of UASBR: PHT—POME holding tank; PP—Peristaltic pump; FM—Flow meter; MV—Manual valve; M—Mixture; SV—Sampling valve; CKD—Cement kiln dust tank (slaking solution); BPT—Biogas purification tank; WT—Water tank; TS—Temperature sensor; HP—Heating probe; P—Pump.

FIG. 2 illustrates operational parameters and performance of the reactors at 10 g/l CaO: COD removal efficiencies and VFA concentration of R1, R2, R3, R4, R5 and R6 after 150 days.

FIG. 3a-3c illustrate scanning electron micrographs (SEM) of the granule: (a) Archaea of (Methanosarcina sp.) the seed sludge and granules sampled on day 150; (b) bisected granules; (c) outer surface of the granule.

FIG. 4a-4d illustrate SEM of smooth surface of granule with large opening cavities likely for biogas escape: (a) Control—WD 4.0 mm, scale 200 μm; (b) WD 4.0 mm, scale 200 μm at 60 days; (c) (WD 4.5 mm, scale 200 μm at 90 days); (d) (WD 4.5 mm, scale 200 μm at 150 days).

FIG. 5 illustrates operational parameters and performance of the reactors: effluent CH₄ production concentrations of R1, R2 and R3.

### DETAILED DESCRIPTION OF PREFERRED EMBODIMENTS

Detailed descriptions of preferred embodiments of the present invention are disclosed herein. It should be understood, however, that the embodiments are merely exemplary of the present invention, which may be embodied in various forms. Therefore, the details disclosed herein are not to be interpreted as limiting, but merely as the basis for the claim and for teaching one skilled in the art of the invention.

Particularly, the present invention relates to a use of calcium oxide-cement kiln dust (CaO-CKD) of a concentration range from 1.5 gL⁻¹ to 20 gL⁻¹ for anaerobic granulation of palm oil mill effluent. The present invention also relates to a process to produce biogas from palm oil mill effluent using calcium oxide-cement kiln dust (CaO-CKD) wherein steps include inoculating palm oil mill effluent sludge in a reactor, conducting anaerobic digestion on the sludge and conducting anaerobic granulation of palm oil mill effluent.

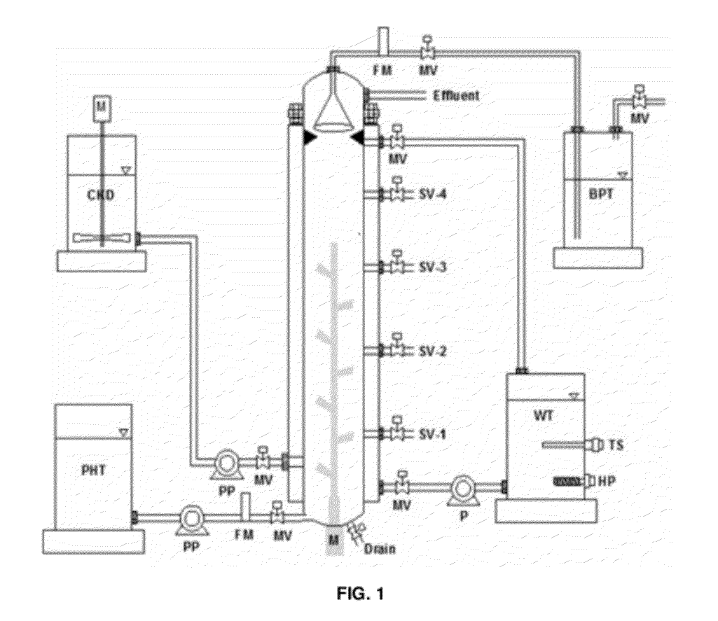

FIG. 1 shows an exemplary experimental setup of the present invention. As used herein the biogas refers to methane.

Various anaerobic processes were studied in recent years for the treatment of municipal wastes, industrial wastes, such as anaerobic digester, fluidized bed reactor, sequencing batch reactor, up-flow anaerobic sludge blanket (UASB) reactor, anaerobic membrane bioreactor, among others. Among all these reactor process, UASB was the most promising technology working on different scale and applied in different wastewater treatment.

Upflow anaerobic sludge blanket (UASB) reactor was operated continuously at 35° C. for 150° C. to investigate the effect of calcium oxide on the sludge granulation and methanogenesis during start-up. Treatment of palm oil mill effluent (POME) emphasizing the influence of varying organic loading rates (OLR). The high performance of the UASB reactor is deeply dependant on anaerobic granular sludge. The processes perform well at high organic loading rates (OLR) with low operating costs and also produce usable biogas.

Research has proven that some metal ions, such as Ca²⁺, Fe²⁺, Al³⁺, Mg²⁺, CaO and Ca(OH)₂ enhance the granulation and play an important role in microbial aggregation, thus calcium oxide-cement kild dust pretreatment can be used yet to improve the performance of the biological process granulation of POME. The biodegradable components in the effluents coupled with calcium oxide-cement kiln dust (CaO-CKD) for the advantages of anaerobic granulation over other treatment method makes it an inventive technology.

In general, granules normally lose strength and stability because the decay starts at the centre due to substrate limitation. In contrast, results obtained showed granule disintegration was not experienced while operating a UASB reactor under low OLR (<1.5 kgCOD m⁻³ day⁻¹). Therefore, dosing the CaO-CKD has been used as a catalyst to accelerate anaerobic granulation process.

When reactor was fed with the 15.5 to 65.5 g-COD gL⁻¹ at an OLR of 4.5 kg-COD/m³·d, up to 94.9% of COD was removed suggesting the feasibility of CaO-CKD using UASB process for treating of POME.

Characteristics of POME is shown below in Table 1:

TABLE 1
Characteristics of POME

| | general POME | EIA |
|---|---|---|
| parameter | characteristics | Standards |
| Temp. | 55.5 | 45 |
| pH | 4.5 | 5.0-9.0 |
| BOD | 40000 | 50 |
| COD | 650000 | 100 |
| sCOD | 30500 | |
| VSS | 20000 | 400 |
| TS | 45000 | |
| TVS | 26300 | |
| TP | 950 | |
| TOC | 25000 | |
| O and G | 1500 | 50 |
| NH₃—N | 90 | 150 |
| TKN | 890 | |
| TN | 945 | 200 |
| VFA | 1900 | |
| SO₄ | 5 | |
| Lignin | 130 | |
| Zn | 0.002 | |
| Br | 0.004 | |
| Fe | 0.005 | |
| Mn | 0.001 | |

*All parameters are in mg L⁻¹ except pH
^{a}as TSS
^{b}as total nitrogen

Characteristics of CKD is shown below in Table 2:

TABLE 2
Characteristics of CKD

| | Dry-kiln | Dry-kiln |
|---|---|---|
| | CKD (% | CKD (% |
| | by | by |
| Parameter | weight) | weight)^{a} |
| pH | 13.6* | — |
| CaO | 65 | 44.9 |
| SiO₂ | 11.6 | 9.64 |
| Al₂O₃ | 6.1 | 3.39 |
| Fe₂O₃ | 3.3 | 1.10 |
| MgO | 1.1 | 1.29 |
| K₂O | 1.69 | 2.4 |
| SO₃ | 5.4 | 6.74 |
| Particle | <25 μm | 1-40 |
| size | | |

*unitless parameter
^{a}Adaska and Taubert (2008)

The efficiency of CaO-CKD with applied CaO doses of 1.5 to 30 gL⁻¹ in batch experiment showed that 10 g CaO/L exposure was found most suitable for highest degradation of VFA, butyrate and acetate parameters.

Influent CaO-CKD concentration, which was varied from 1.5 gL⁻¹, corresponded to not excess CaO to 20 gL⁻¹. The optimum CaO-CKD concentration is preferably at 10 gL⁻¹. The relationship between the CaO concentration in the feed and the biomass accumulation, specific granulation and methanogenic activity, density and compositions of granules (MLVSS) was determined. This study was conducted to examine the treatability of POME and effects of CaO on the granulation process in UASB reactors. The biomass concentration profiles along the reactors and the size distribution of granules were also measured to track and to assess the granulation, methanogenic and COD removal.

The pH is one of the key factors that influence anaerobic digestion of POME because methane producing microorganism requires a neutral to slightly alkaline environment in order to granulation and methanogenesis from POME. Optimum pH for granulation is between 6.8 and 7.2, while pHs lower than 4 and higher than 9.5 is not tolerable.

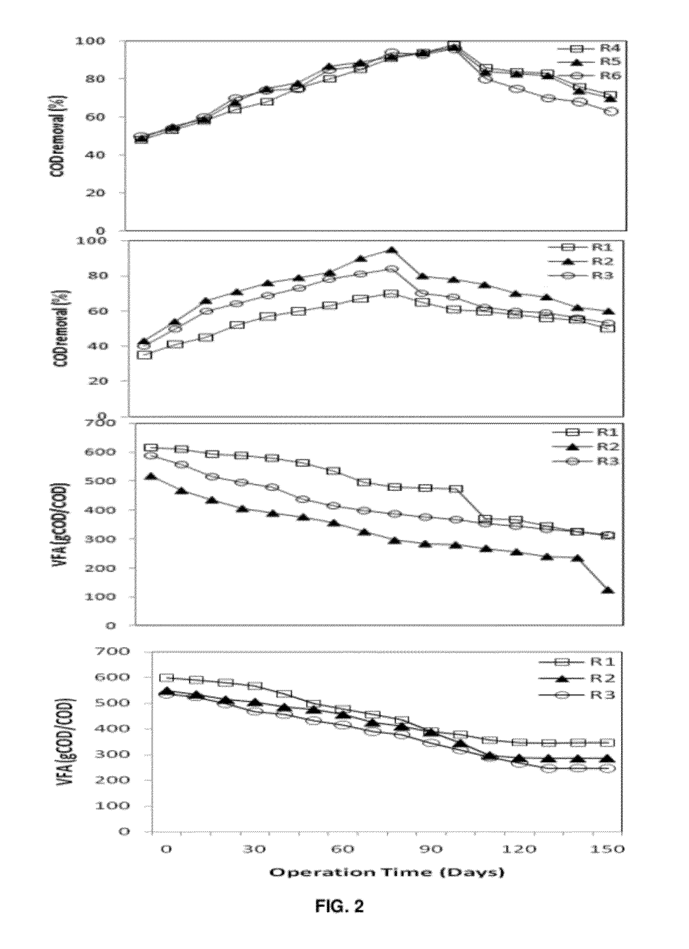

The results were found the ratio of volatile solids/total solids (VS/TS) and volatile fatty acids, of the anaerobic sludge in the UASB decreased significantly after a long-term operation due to the precipitation of calcium carbonate in the granules. The performance of the reactors, in terms of COD removal efficiency, effluent VSS concentration, granulation and methane production, was continuously improving with operation in FIG. 2.

The operational conditions and performance of the reactor for 150 days, starting from 20 days, the COD removal efficiencies were low.

The reactor control (R2) had the highest COD in effluent. On-going of experimental progress, the COD removal efficiencies of all the reactors (R2-R6) was found generally increasing. Calcium oxide added reactor showing faster COD removal efficiencies than that of R1 in FIG. 2.

The following examples further illustrate but by no means limit the scope of present invention:

### POME Sludge and Nutrient Medium Preparation

Accordingly, bench scale experiments were carried out with five 500 mL flasks of POME to examine the neutralising effects of CaO-CKD. The runs were performed at the POME natural pH and at pH 7.5 (obtained with the addition of CaOP-CKD). Typically, batch experiments were performed in a laboratory semi batch column reactor consisted of a 100 cm height cylindrical tube with a 4 cm internal diameter. A Schott ceramic porous diffuser (porosity 4, 10-16 mm) was placed in the bottom of the reactor for CaO-CKD distribution.

Next, methanogenic sludge was withdrawn from an anaerobic digester which operated at organic loading rate of 15 COD L⁻¹ d⁻¹ 73 and 35° C. over 3 months. The nutrient medium used was consisted of (gL⁻¹): NH4Cl (0.5), K2HPO4 (15), MgCl2.6H2O (0.2), CaCl2 (0.05), NaHCO₃ (1.5) and trace element solution (1 ml L⁻¹).

The UASB reactors was inoculated with 15 gL⁻¹ of CaO-CKD with 350 mL seed sludge and acclimatization of sludge with POME was done by daily bench fed of diluted sludge (5 g-COD/L) for five days. The average volatile suspended solids (VSS) of the sludge after 5 days bench fed were 11.3 gL⁻¹. Continuous feeding was started with an initial organic loading rate (OLR) of 1.5 kg-COD/m³·d and HRT of 4 days.

The HRT was kept constant throughout the study experimental period.

The influent COD concentration was 6 gL⁻¹ for the first 20 days, and then it was increased to 10 gL⁻¹ (OLR=2.5 kg-COD/m³·d) for further 17 days. The third and last COD concentration was 16 g/L (OLR=4 kg-COD/m³·d) from 38 to 150 days.

The reactor was monitored daily for volatile fatty acids, effluent VSS, MLVSS and methane yields.

### Anaerobic Digestion of POME

The batch test using CaO-CKD for the degradation of POME sludge mainly depends on the formation stable micro-environment. Microbial activity was examined with initial COD concentration from diluted settled POME, biomass concentration of 5067 g COD/L, 3293 mg/L alkalinity calcium carbonate. Alkalinity increased with the decrease of VFA and COD. The batch test conditions and performance of the different doses, concentrations of COD, VSS, and VFA in the influent and the COD removal efficiencies can be further summarized in Table 3 below:

TABLE 3
Chemical analysis parameters of POME effluent treated at various
CaO-CKD dosage and fermentation reaction times:

| Parameters | 0 | 1.5 | 3.0 | 5 | 10 | 15 | 20 |
|---|---|---|---|---|---|---|---|
| VFA | 1930 | 1850 | 1720 | 1539 | 1080 | 1150 | 1256 |
| VSS | 3078 | 3173 | 3230 | 3363 | 3490 | 2550 | 2187 |
| COD | 5067 | 4090 | 4050 | 3010 | 2020 | 2180 | 3012 |
| Alkalinity | 3293 | 2789 | 2950 | 3535 | 4036 | 4862 | 5020 |
| Butyric acid | 175 | 155 | 127 | 106 | 95 | 56 | 90 |
| Acetic acid | 369 | 495 | 560 | 620 | 610 | 650 | 715 |

* All parameters are in mg L⁻¹

The degradation of VFA resulted in an increase of VSS and MLVSS. The VSS and MLSS concentration (see Table 3) during the batch test and biomass build-up phase while treating POME with CaO-CKD are also summarized in Table 4 below:

TABLE 4
Effect of CaO-CKD on various parameters in POME at different
fermentation reactor using acetate as substrate carbon source for
the biomass:

| | | | | | Sludge | |
|---|---|---|---|---|---|---|
| | | | MLVSS/ | | Volume | |
| | | | MLSS | Influent | Index | % COD |
| Reactors | MLSS | MLVSS | Ratio | COD | (mlg⁻¹) | removal |
| 1.5 | 30000 | 20000 | 2200 | 55000 | 35 | 39.5 |
| 3.0 | 3500 | 30000 | 4300 | 45000 | 120 | 61.9 |
| 5.0 | 37000 | 35000 | 3500 | 43000 | 146 | 73.7 |
| 10.0 | 55000 | 40000 | 3100 | 40000 | 209 | 78.6 |
| 15.0 | 41000 | 35000 | 2600 | 41000 | 124 | 70.3 |
| 20.0 | 35000 | 31000 | 2100 | 42000 | 112 | 62.5 |

* All parameters are in mg L⁻¹

As shown in Table 5, the granules contained 32.3±4.4% dried mass:

TABLE 5
Profile of biomass during dosage of (10 gL⁻¹ CaO-CKD) and
fermentation reaction after 150 days:

| Influent CaO | | | | | | |
|---|---|---|---|---|---|---|
| concentration | | | | | | |
| (g/L) | R1 | R2 | R3 | R4 | R5 | R6 |
| Cao in | 950 | 7050 | 5920 | 3739 | 2780 | 1350 |
| Granules | | | | | | |
| (mg/L) | | | | | | |
| Dry weight (% | 11.78 | 32.33 | 22.50 | 20.63 | 19.98 | 18.50 |
| of wet sludge) | | | | | | |
| MLVSS/MLSS | 55.3 | 75.5 | 72.8 | 71.2 | 45.9 | 29.4 |
| Density of | 1000 | 1900 | 1600 | 1400 | 1200 | 1100 |
| granules (g/L) | | | | | | |
| Size of the | <0.6 | <4.2 | <2.6 | <2.0 | <1.5 | <1.5 |
| granules (mm) | | | | | | |

When calcium oxide concentration in the substrate was raised, the water content of the granules decreased and the total dry mass increased. In the dry materials, the proportion of minerals increased significantly while that of organics reduced as indicated by the decrease in MLVSS/MLSS (see Table 4).

This indicates that the presence of CaO-CKD increased the dry mass of the granules mainly by increasing the concentration of minerals in the granules. The increased mineral content was very likely the result of more calcium hydroxide, oxides of carbonates and aluminium precipitates trapped in the granules. The density of the granules also increased with increasing CaO-CKD concentration in the feed (see Table 5) indicates the changes in the granular composition.

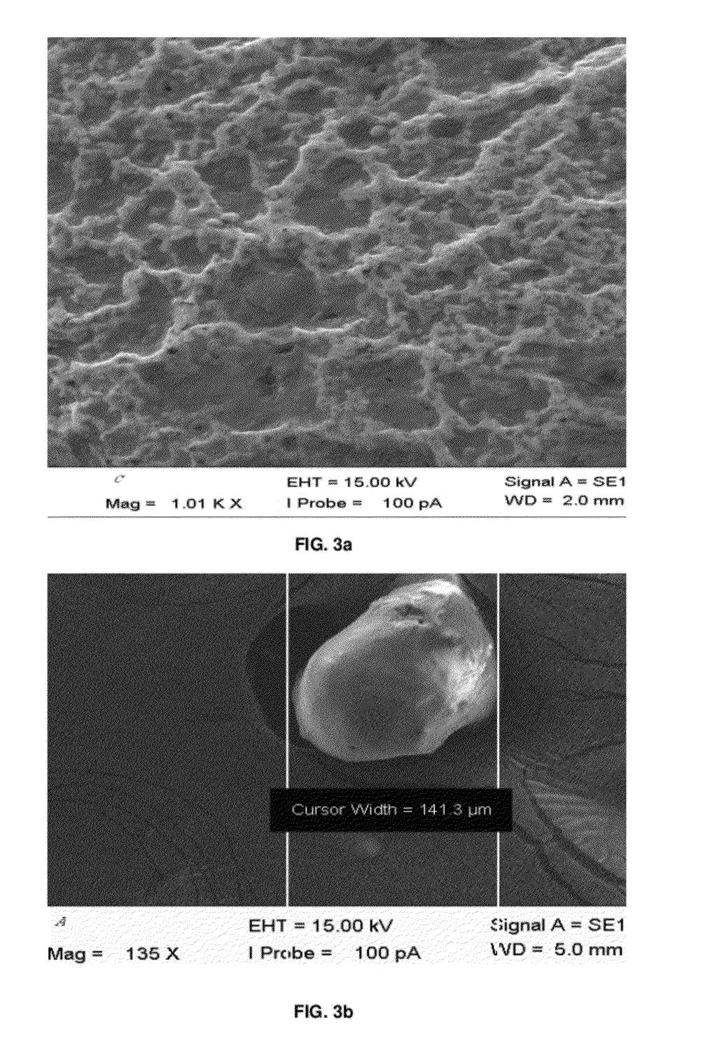

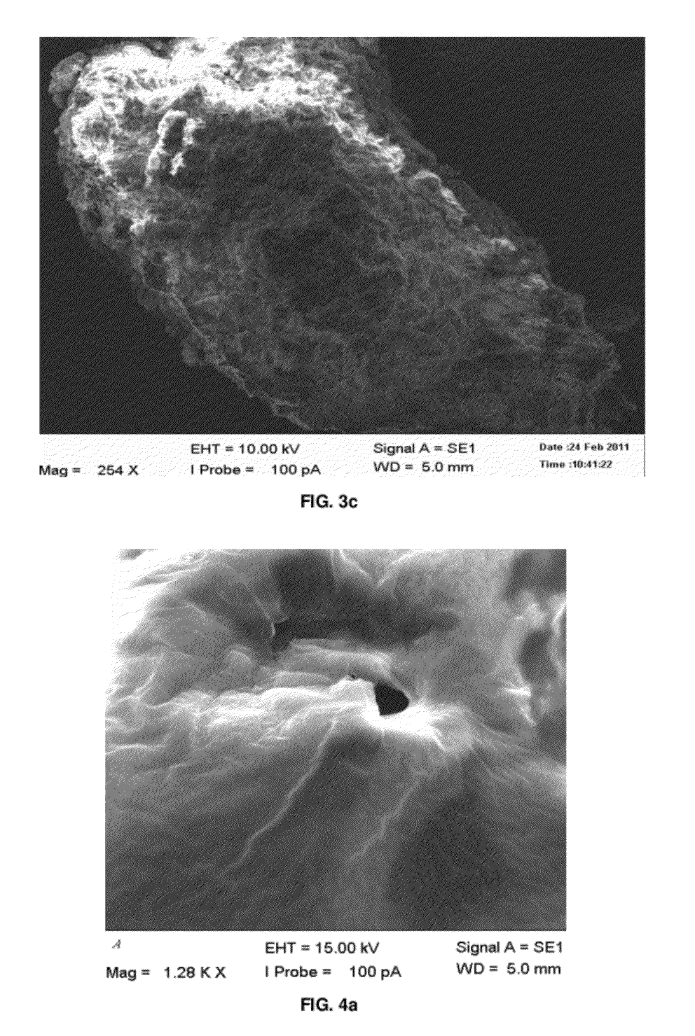

FIG. 3a-3b further illustrates the spatial and porous arrangement of the granules surface. FIGS. 3a-3c show Methanosarcina spp.-like organism appear packed in the core of developed granules.

### Anaerobic Granulation of POME

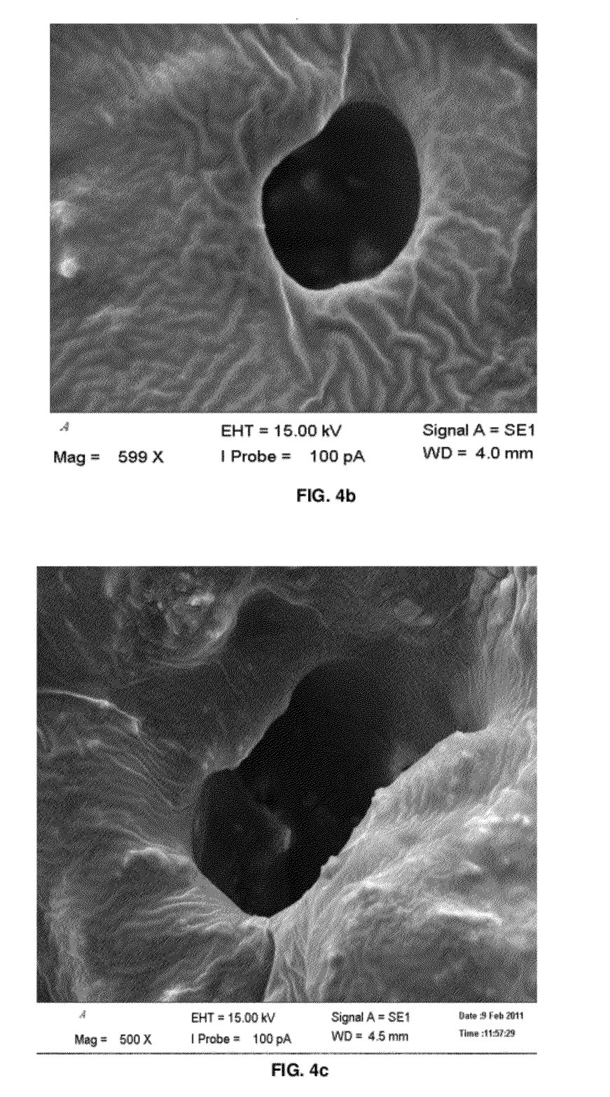

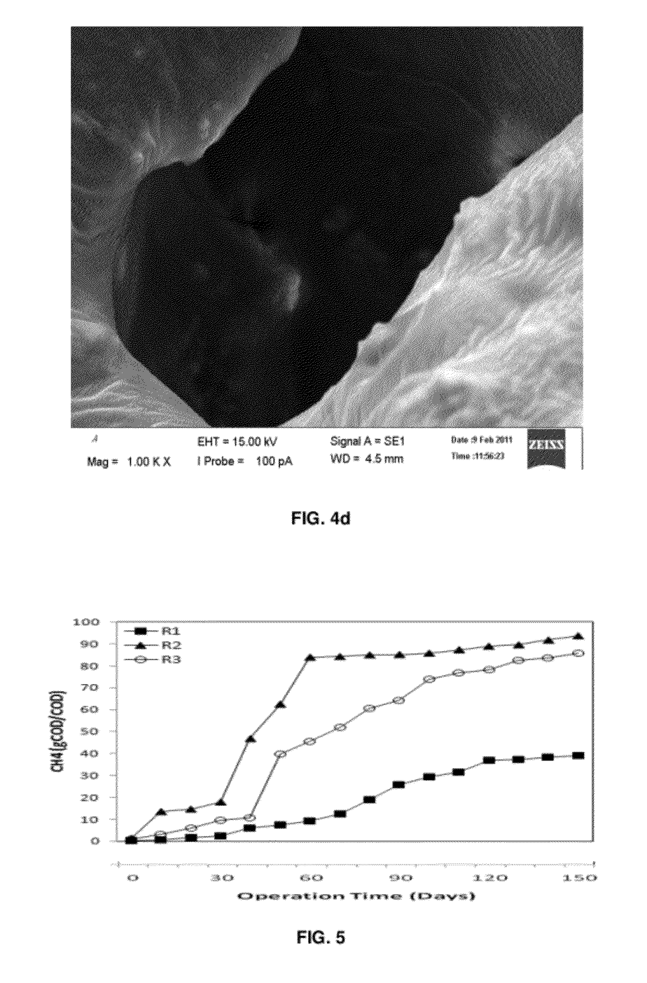

While in this studies where the addition of CaO-CKD was found to be detrimental to granulation, resulting in beneficial effect of developing large biogas cavities after 90 days less escape than 150 days was showing bigger escape (see FIGS. 4a-4d). The present studies clearly demonstrate that (10 gL⁻¹) CaO-CKD concentrations had a positive influence on sludge granulation process and that high calcium concentrations (20 gL⁻¹) had a negative influence on granulation.

Methane production (m3/m3 d, per m3 of reactor per day) in the reactors is shown in FIG. 5. With increasing influent COD, the methane production increased. The production in R1 was significantly lower than that in R2. Especially, before and after the circulation from day 90 to day 96 (under the same COD concentration of 12.0 g/L), the methane production in R2 was increased significantly from 1.19 m3/m3 d to 1.51 m3/m3 d, compared to 0.99 m3/m3 d to 1.07 m3/m3 d in R1. This indicated that the circulation could effectively enhance methanogens activity of R2.

I claim:

1. A use of calcium oxide-cement kiln dust (CaO-CKD) at a concentration range from 1.5 gL⁻¹ to 20 gL⁻¹ for anaerobic granulation of palm oil mill effluent.

2. A use as claimed in claim 1, wherein the optimum concentration is preferably at 10 gL⁻¹.

3. A use as claimed in claim 1, wherein the anaerobic granulation is carried out at a pH range from 6.8 to 7.2.

4. A process to produce biogas from palm oil mill effluent using calcium oxide-cement kiln dust (CaO-CKD) at a concentration range from 1.5 gL⁻¹ to 20 gL⁻¹ wherein steps include:
i) inoculating palm oil mill effluent sludge in a reactor;
ii) conducting anaerobic digestion on the sludge; and
iii) conducting anaerobic granulation of palm oil mill effluent.

5. A process as claimed in claim 4, wherein the biogas is methane.

6. A process as claimed in claim 4, wherein the reactor is an upflow anaerobic sludge bed (UASB) reactor.

7. A process as claimed in claim 4, wherein the upflow anaerobic sludge bed (UASB) reactor is operated continuously at a temperature range from 35° C. to 150° C.

8. A process as claimed in claim 4, wherein the upflow anaerobic sludge bed (UASB) reactor is operated at an organic load rate (OLR) of less than 1.5 kgCOD m⁻³ day⁻¹.

9. A process as claimed in claim 4, wherein the optimum concentration is preferably at 10 gL⁻¹.

10. A process as claimed in claim 4, wherein the anaerobic granulation is carried out at a pH range from 6.8 to 7.2.
